(19) United States
(12) Patent Application Publication
(10) Pub. No.: US 2009/0076844 A1
(43) Pub. Date: Mar. 19, 2009

(54) SYSTEM AND METHOD FOR REMOTE DELIVERY OF A THERAPEUTIC TREATMENT

(75) Inventor: Michael Joseph Koegen, Tecate (MX)

Correspondence Address: SUGHRUE MION, PLLC, 2100 PENNSYLVANIA AVENUE, N.W., SUITE 800, WASHINGTON, DC, 20037, US

(73) Assignee: Natural Light de Mexico, Tecate (MX)

(21) Appl. No.: 12/174,575

(22) Filed: Jul. 16, 2008

Related U.S. Application Data
(60) Provisional application No. 60/950,050, filed on Jul. 16, 2007.

(51) Int. Cl. G06Q 50/00

(52) U.S. Cl. 705/2

(57) ABSTRACT

A system and method for remote delivery of a therapeutic treatment using a low-level light therapy (“LLLT”) device permits a user at a remote location to select and purchase a therapeutic session on a remote computer. The remote computer then transmits a request for the therapeutic session to a server at a treatment center, which then selects the corresponding treatment program and sends the program to the remote computer. The remote computer then transmits the treatment program to the LLLT device for executing the treatment program in order to deliver a therapeutic treatment to a user. The treatment program is then deleted from the LLLT device to preserve the security of the treatment program and discourage theft or misuse of the LLLT device.

### CROSS REFERENCE TO RELATED APPLICATIONS

This application claims the benefit of priority to U.S. provisional application No. 60/950,050, filed Jul. 16, 2007, the entirety of which is incorporated herein by reference.

### BACKGROUND OF THE INVENTION

1. Field of the Invention

The present invention relates to systems and methods for remote delivery of a therapeutic treatment, and more specifically to a system for ordering and receiving a Low Level Light Therapy (“LLLT”) treatment using a LLLT device that is connected to a network for a user to order and receive treatment programs from a treatment center.

2. Background of the Invention

Recent research has revealed and confirmed previous finding that light accelerates biological functions of not only plants but also human beings. This process, by which light applied at specific intensities and wavelengths stimulates the cellular matrix, increasing cellular activity and metabolism, is known by various names such as Low Level Light Therapy (LLLT), Low Level Laser, Bio-Modulation or Cold Laser, amongst others.

The most common application for LLLT is in wound healing and musculoskeletal pain or injury relief Doctors have used it for scar reduction and burns with excellent results. Other research has demonstrated that dramatic histological changes occur in the dermis (skin) when users are exposed to low level light therapy. The changes included development of collagen.

LLLT treatments are now growing in popularity due to their therapeutic benefits for a continually expanding number of conditions and ailments. However, LLLT devices are still difficult to find, and often require traveling long distances to the few locations where LLLT therapies are given. Additionally, as LLLT therapy is completely safe and requires no supervision by a medical professional, there is no need to restrict its use to hospitals or doctor's offices.

As LLLT research continues, more applications will be identified and new treatments can be designed using various levels and patterns of lights to deliver particularly suited therapies. A standalone LLLT device could therefore become obsolete without regular updates or complicated computer equipment capable of implementing updated treatments. This will correspondingly increase the cost of each LLLT device, thus reducing its popularity and availability to those who desire LLLT treatments.

Therefore, it is desired to improve the availability of LLLT devices and improve the design and capabilities of LLLT devices while significantly reducing the cost of each deice.

### SUMMARY OF THE INVENTION

The present invention relates to systems and methods for remote delivery of a therapeutic treatment using a low level light therapy (“LLLT”) device. A user at a remote location that desires a LLLT treatment interacts with a computer interface to select and purchase a desired LLLT treatment. The interface communicates the user's selection and payment information to a treatment center that stores LLLT treatment programs and account information for each user. The treatment center then transmits the selected treatment to the computer at the remote location, which then relays the selected treatment program to a LLLT device at the remote location. The user may then activate the treatment program on the device and receive the LLLT treatment. Upon completion of the LLLT treatment, the treatment program is cleared from memory on the LLLT device.

The invention also relates to a system for remote delivery of a therapeutic treatment comprising a remote computer at a remote location with a graphical user interface for a user to request a therapeutic treatment; a network for transmitting the treatment request from the remote computer to a treatment center; a server at the treatment center for receiving the treatment request and transmitting a treatment program corresponding to the selected treatment to the remote computer over the network; and a therapeutic device at the remote location for receiving the treatment program from the remote computer and executing the treatment program to deliver a therapeutic treatment to the user.

In a further embodiment of the system, the therapeutic device is a low-level light treatment (“LLLT”) device.

In a further embodiment of the system, the network is the Internet.

In a further embodiment of the system, the graphical user interface is a website hosted at the server and accessed by the remote location over the Internet.

In a further embodiment of the system, the user must purchase the selected treatment before the server transmits the treatment program to the remote computer.

In a further embodiment of the system, the server processes the purchase.

In a further embodiment of the system, the treatment program is deleted from the therapeutic device upon completion of executing the treatment program at the LLLT device.

The invention also relates to a method for remote delivery of a therapeutic treatment comprising the steps of receiving a request for a therapeutic treatment at a remote computer in a remote location; transmitting the request from the remote computer over a network to a treatment center; receiving the request at a server in the treatment center; transmitting a treatment program from the server to the remote computer, wherein the treatment program corresponds to the treatment request; delivering the treatment program from the remote computer to a therapeutic device at the remote location; and executing the treatment program to deliver a therapeutic treatment to the user.

In a further aspect, the method comprises selecting a low-level light treatment (“LLLT”) device as the therapeutic device.

In a further aspect, the method comprises transmitting the request from the remote computer to the treatment center over the Internet.

In a further aspect, the method comprises creating a website hosted at the server as the graphical user interface that is accessed by the remote location over the Internet.

In a further aspect, the method comprises requiring a user to purchase a treatment before transmitting the request from the remote computer to the server.

In a further aspect, the method comprises processing the purchase at the server.

In a further aspect, the method comprises deleting the treatment program from the therapeutic device upon completion of executing the treatment program at the LLLT device.

The invention also relates to a computer program product embodied on a computer readable medium for remote delivery of a therapeutic treatment, comprising computer code for receiving a request for a therapeutic treatment at a remote computer in a remote location; transmitting the request from the remote computer over a network to a treatment center; receiving the request at a server in the treatment center; transmitting a treatment program from the server to the remote computer, wherein the treatment program corresponds to the treatment request; delivering the treatment program from the remote computer to a therapeutic device at the remote location; and executing the treatment program to deliver a therapeutic treatment to the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 depicts an illustration of a Low Level Light Therapy (“LLLT”) device, according to one aspect of the invention;

FIG. 2 depicts a block diagram of a system for remote delivery of an LLLT treatment from a treatment center to a remote location over a network; according to one aspect of the invention;

FIG. 3 depicts the steps of a method for remote delivery of an LLLT treatment; according to one aspect of the invention; and

FIG. 4 illustrates an exemplary embodiment of a computer platform upon which the inventive system may be implemented.

### DETAILED DESCRIPTION OF THE INVENTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The present invention relates to systems and methods for remote delivery of a therapeutic treatment using a low level light therapy (“LLLT”) device. A user at a remote location that desires a LLLT treatment interacts with a computer interface to select and purchase a desired LLLT treatment. The interface communicates the user's selection and payment information to a treatment center that stores LLLT treatment programs and account information for each user. The treatment center then transmits the selected treatment to the computer at the remote location, which then relays the selected treatment program to a LLLT device at the remote location. The user may then activate the treatment program on the device and receive the LLLT treatment. Upon completion of the LLLT treatment, the treatment program is cleared from memory on the LLLT device.

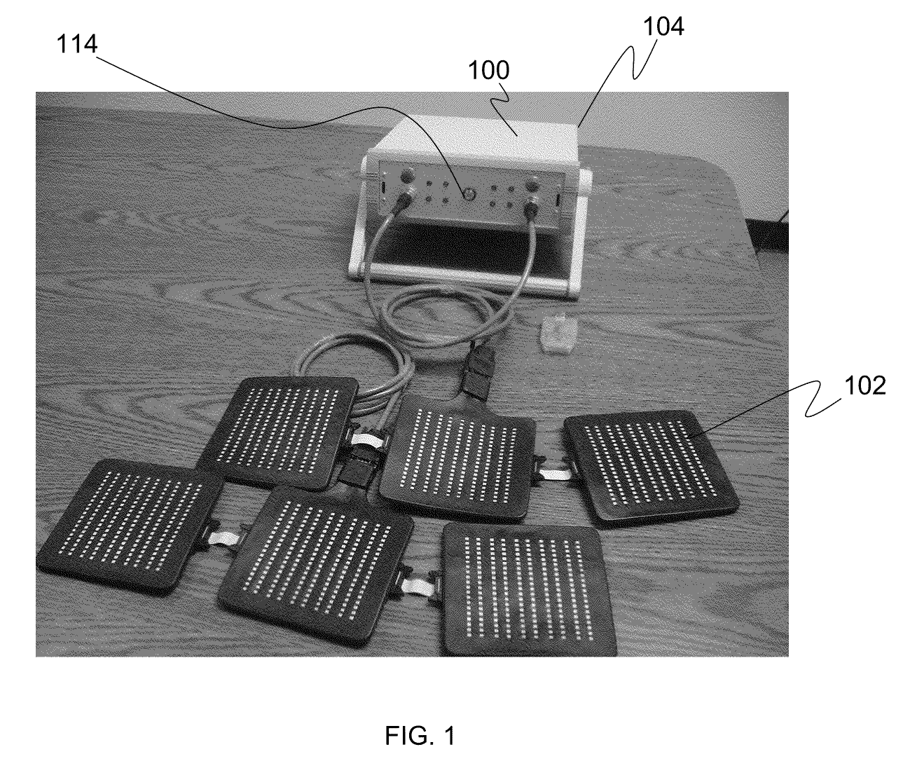

In one embodiment, the LLLT device uses high intensity, super bright Aluminum Gallium Arsenide LEDs. These LEDs effectively stimulate the cell's mitochondrion membrane with 200 (630 nm) red light diodes and (880 nm) infrared light diodes mounted together on the same lightweight pads. FIG. 1 shows an illustration of one embodiment of an LLLT device 100 including several light pads 102 of LED lights, and a main device housing 104. The flexible pads allow for better coverage of areas that have formerly proven hard to reach.

The LEDs, arranged on flexible pads, are directed by a controller in the housing 104 using 21 preprogrammed protocols that deliver multiple frequencies for optimum effectiveness on a variety of cosmetic problems. The protocols control the power-output, pulse frequency; waveform and duty cycle of both the red and infrared diode and activate them sequentially, independently on in combination.

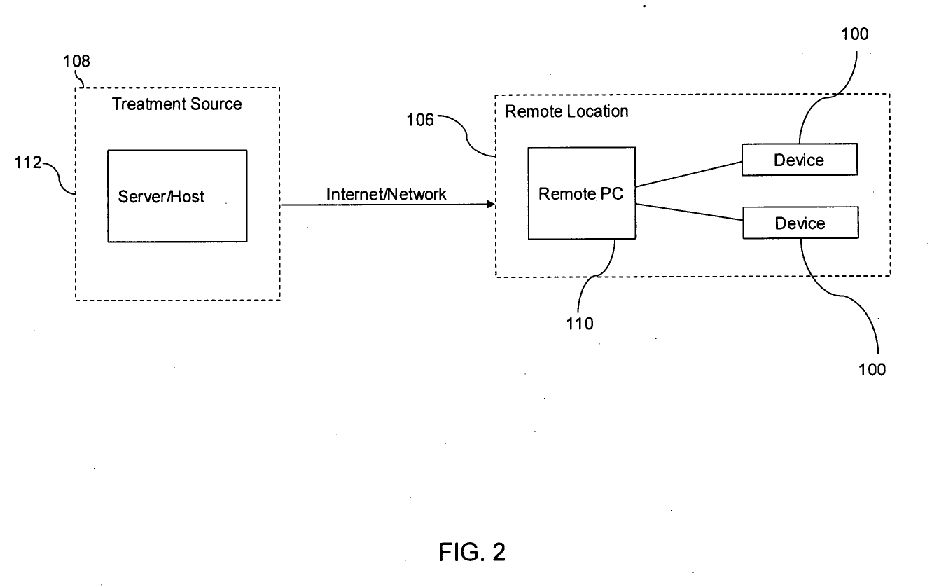

One aspect of a system for remote delivery of an LLLT treatment is depicted in FIG. 2. A therapeutic device, such as a photo-biostimulation low-level light therapy (“LLLT”) device 100 of FIG. 1, is located at a remote location 106 for use by a user. Treatments, described in more detail below, are delivered to a user in short sessions, and vary depending on the particular ailment of the user or desired therapeutic benefit. The treatments are specific software programs that are run on the LLLT device 100 to vary the light intensity and flashing patterns of lights on the device in accordance with a desired therapeutic benefit.

The treatments are ordered by the user from a treatment center 108 through an Internet-based treatment website. The user can be a patient needing treatment or a treatment provider that supervises the treatment or the remote location that provides the treatment. In one embodiment, the user uses a remote computer 110 at the remote location 106 to interact with a server 112 or other computer at the treatment center 108 that is hosting the website. The remote computer 110 and LLLT device 100 can therefore be located anywhere with a connection to the Internet.

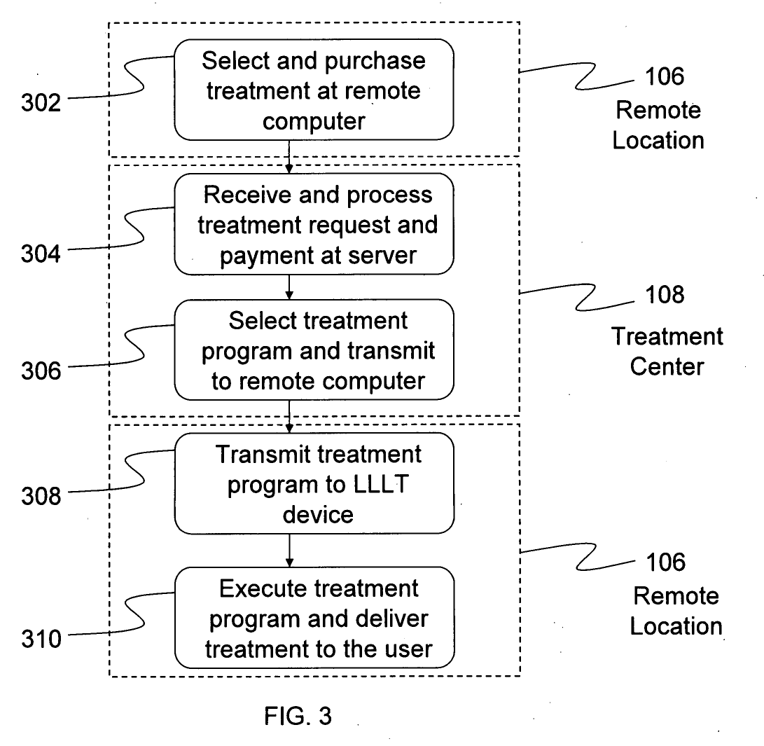

In one aspect of a method for remote delivery of a therapeutic treatment shown in FIG. 3, the user at the remote location 106 interacts with a graphical user interface on the treatment website to select a LLLT treatment, schedule a time for delivery of the treatment, and purchase the treatment, all in advance of treatment delivery (step 302). The treatment website can be accessed from any computer or mobile device, such as a cell phone, as long as the device accessing the website contains the ability to subsequently transmit the purchased treatment to the LLLT device 100.

The selected treatment and payment information are transmitted to the treatment center 108, where the server 112 processes the request and the payment (step 304). The server 112 selects a treatment program that corresponds to the selected treatment, after which the treatment program is transmitted back to the remote computer 110 at the remote location (step 306). Finally, the remote computer 110 transmits the treatment program to the LLLT device 100 (step 308) so the LLLT device 100 can then execute the treatment program and deliver the LLLT treatment to the user (step 310).

Further describing one aspect of the method above, once the user has transmitted the payment and selected a treatment program, the treatment program is transmitted from the treatment center 108 to the remote computer 110, where it is then transmitted wirelessly to the LLLT device 100. In one embodiment, the LLLT device 100 uses a proprietary wireless connection protocol to communicate with the remote computer 110 in order to receive the ordered treatment. The remote computer 110, in this embodiment, is connected with a proprietary wireless transmitter (not shown) that attaches to a computer's Universal Serial Bus (“USB”) port. However, the computer 110 and LLLT device 100 could also communicate via an existing wired or wireless network (i.e. 802.11a/b/g/n) or a known wireless transmission protocol (Bluetooth®), cellular transmission, etc.). A proprietary wireless system provides the advantage of easy setup for the remote user, since it would not require an existing wireless network. Additionally, with the proprietary wireless system, the LLLT device 100 does not require all the standard components of a network-ready computer, which reduces the cost of manufacturing the device and eliminates the need for the user to set up the device to connect to a network.

Once the treatment program is transmitted to the LLLT device 100, the user may begin the treatment at the scheduled time selected previously. In one embodiment, the user can enter a private treatment room at the remote location 104 where the device 100 is set up and ready to use. Only minimal controls, if any, are required on the device 100 to initiate the treatment session, as all of the information on the treatment is received from the remote computer 110 and stored temporarily within the device memory. In one embodiment, the treatment session cannot be interrupted once it has begun, in order to provide the maximum benefit of the treatment to the user. Various indicator lights 114 may be positioned on the device 100 to indicate the beginning or end of a treatment session. Once the treatment session is complete, the treatment program is erased from the LLLT device memory.

The system and method described above provides numerous benefits. Since the treatment program is delivered from the treatment center 108 each time a treatment is ordered, and deleted from the device memory immediately upon completion of the treatment session, the LLLT device 100 preserves the security of the particular treatment programs since they are not stored on the device itself. This security helps the treatment center 108 protect its particular treatment programs from copying, and discourages theft or misuse of the LLLT device 100, since the LLLT device 100 would not have any ability to deliver treatments without a network connection to the treatment center 108. Additionally, the LLLT device 100 doesn't require updating of the treatment programs, since the treatment programs are stored at the treatment center 108 and can be updated at there as well. Therefore, a treatment developer can develop new treatment programs and quickly upload them at the treatment center 108, requiring only minimal effort to load the treatment programs on the treatment center 108 and, if needed, update the treatment center website to reflect the new or updated treatment options.

The treatment system also simplifies the process for the remote treatment provider who, for example, may purchase one or more LLLT devices for use by customers. The remote treatment provider can rely upon the treatment website to interact with a user and determine the treatment needed, the schedule for delivering the treatment, and the payment for the treatment. Thus, the remote treatment provider has no responsibility other than maintaining the basic functionality of the remote computer 110 and the LLLT device 100.

In one embodiment, the user will create an account using the treatment website so that treatments can be delivered without requiring the user to enter certain ordering and payment information each time. The account information is stored on the server 112 at the treatment center 108, and in a further embodiment, a particular user's treatment history can be also stored on the server 112, so that a user can access his or her history of treatments and determine if additional treatments are needed, or if alternate types of treatments are needed.

In one embodiment, the remote location 104 is a physician's office or hospital with a professional provider of therapeutic treatments. However, due to the safe nature of the treatments, a licensed professional is not required to oversee or deliver the LLLT treatments, so that the remote location 106 could be a spa, physical therapy office, or even a user's private residence.

In one embodiment, in order to transmit a purchased treatment from the treatment center 108 to a remote computer 110 and then via a wireless transmitter connected to the LLLT device 100, a set of software drivers must be loaded onto the remote computer 110 by the user at the remote location 106. In one embodiment, a software application is also loaded onto the remote computer 110 to manage the connection to the device or devices 100, especially if more than one device is being operated in a given remote location. The application is capable of coordinating the delivery of treatments to multiple devices connected to the same remote computer, if such a configuration is desired.

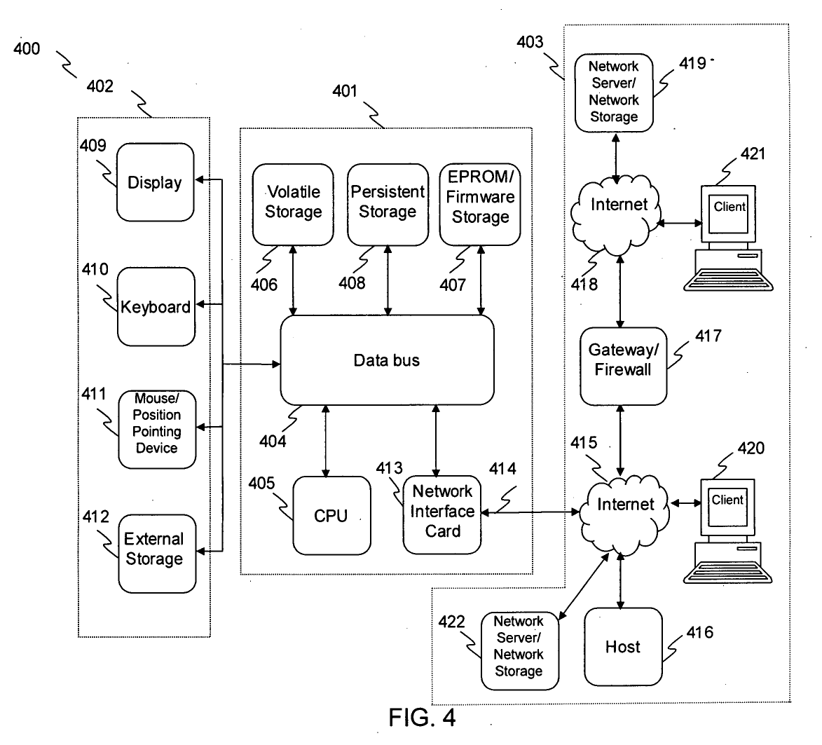

FIG. 4 is a block diagram that illustrates an embodiment of a computer/server system 400 upon which an embodiment of the inventive methodology may be implemented. The system 400 includes a computer/server platform 401, peripheral devices 402 and network resources 403.

The computer platform 401 may include a data bus 404 or other communication mechanism for communicating information across and among various parts of the computer platform 401, and a processor 405 coupled with bus 401 for processing information and performing other computational and control tasks. Computer platform 401 also includes a volatile storage 406, such as a random access memory (RAM) or other dynamic storage device, coupled to bus 404 for storing various information as well as instructions to be executed by processor 405. The volatile storage 406 also may be used for storing temporary variables or other intermediate information during execution of instructions by processor 405. Computer platform 401 may further include a read only memory (ROM or EPROM) 407 or other static storage device coupled to bus 404 for storing static information and instructions for processor 405, such as basic input-output system (BIOS), as well as various system configuration parameters. A persistent storage device 408, such as a magnetic disk, optical disk, or solid-state flash memory device is provided and coupled to bus 401 for storing information and instructions.

Computer platform 401 may be coupled via bus 404 to a display 409, such as a cathode ray tube (CRT), plasma display, or a liquid crystal display (LCD), for displaying information to a system administrator or user of the computer platform 401. An input device 420, including alphanumeric and other keys, is coupled to bus 401 for communicating information and command selections to processor 405. Another type of user input device is cursor control device 411, such as a mouse, a trackball, or cursor direction keys for communicating direction information and command selections to processor 404 and for controlling cursor movement on display 409. This input device typically has two degrees of freedom in two axes, a first axis (e.g., x) and a second axis (e.g., y), that allows the device to specify positions in a plane.

An external storage device 412 may be connected to the computer platform 401 via bus 404 to provide an extra or removable storage capacity for the computer platform 401. In an embodiment of the computer system 400, the external removable storage device 412 may be used to facilitate exchange of data with other computer systems.

The invention is related to the use of computer system 400 for implementing the techniques described herein. In an embodiment, the inventive system may reside on a machine such as computer platform 401. According to one embodiment of the invention, the techniques described herein are performed by computer system 400 in response to processor 405 executing one or more sequences of one or more instructions contained in the volatile memory 406. Such instructions may be read into volatile memory 406 from another computer-readable medium, such as persistent storage device 408. Execution of the sequences of instructions contained in the volatile memory 406 causes processor 405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 405 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 408. Volatile media includes dynamic memory, such as volatile storage 406. Transmission media includes coaxial cables, copper wire and fiber optics, including the wires that comprise data bus 404. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 405 for execution. For example, the instructions may initially be carried on a magnetic disk from a remote computer. Alternatively, a remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on the data bus 404. The bus 404 carries the data to the volatile storage 406, from which processor 405 retrieves and executes the instructions. The instructions received by the volatile memory 406 may optionally be stored on persistent storage device 408 either before or after execution by processor 405. The instructions may also be downloaded into the computer platform 401 via Internet using a variety of network data communication protocols well known in the art.

The computer platform 401 also includes a communication interface, such as network interface card 413 coupled to the data bus 404. Communication interface 413 provides a two-way data communication coupling to a network link 414 that is connected to a local network 415. For example, communication interface 413 may be an integrated services digital network (ISDN) card or a modem to provide a data communication connection to a corresponding type of telephone line. As another example, communication interface 413 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 413 sends and receives electrical, electromagnetic or optical signals that carry digital data streams representing various types of information.

Network link 413 typically provides data communication through one or more networks to other network resources. For example, network link 414 may provide a connection through local network 415 to a host computer 416, or a network storage/server 417. Additionally or alternatively, the network link 413 may connect through gateway/firewall 417 to the wide-area or global network 418, such as an Internet. Thus, the computer platform 401 can access network resources located anywhere on the Internet 418, such as a remote network storage/server 419. On the other hand, the computer platform 401 may also be accessed by clients located anywhere on the local area network 415 and/or the Internet 418. The network clients 420 and 421 may themselves be implemented based on the computer platform similar to the platform 401.

Local network 415 and the Internet 418 both use electrical, electromagnetic or optical signals that carry digital data streams. The signals through the various networks and the signals on network link 414 and through communication interface 413, which carry the digital data to and from computer platform 401, are exemplary forms of carrier waves transporting the information.

Computer platform 401 can send messages and receive data, including program code, through the variety of network(s) including Internet 418 and LAN 415, network link 414 and communication interface 413. In the Internet example, when the system 401 acts as a network server, it might transmit a requested code or data for an application program running on client(s) 420 and/or 421 through Internet 418, gateway/firewall 417, local area network 415 and communication interface 413. Similarly, it may receive code from other network resources.

The received code may be executed by processor 405 as it is received, and/or stored in persistent or volatile storage devices 408 and 406, respectively, or other non-volatile storage for later execution. In this manner, computer system 401 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the method of remote delivery of a therapeutic product. For example, the described software may be implemented in a wide variety of programming or scripting languages, such as Assembler, C/C++, perl, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in the computerized storage system. It is intended that all matter contained in the above description or shown in the accompanying drawings shall be interpreted as illustrative only and not limiting.

What is claimed is:

1. system for remote delivery of a therapeutic treatment comprising:
a remote computer at a remote location with a graphical user interface for a user to request a therapeutic treatment;
a network for transmitting the treatment request from the remote computer to a treatment center;
a server at the treatment center for receiving the treatment request and transmitting a treatment program corresponding to the selected treatment to the remote computer over the network; and
a therapeutic device at the remote location for receiving the treatment program from the remote computer and executing the treatment program to deliver a therapeutic treatment to the user.

2. The system of claim 1, wherein the therapeutic device is a low-level light treatment (“LLLT”) device.

3. The system of claim 2, wherein the network is the Internet.

4. The system of claim 3, wherein the graphical user interface is a website hosted at the server and accessed by the remote location over the Internet.

5. The system of claim 4, wherein the user must purchase the selected treatment before the server transmits the treatment program to the remote computer.

6. The system of claim 5, wherein the server processes the purchase.

7. The system of claim 6, wherein the treatment program is deleted from the therapeutic device upon completion of executing the treatment program at the LLLT device.

8. A method for remote delivery of a therapeutic treatment comprising the steps of:
receiving a request for a therapeutic treatment at a remote computer in a remote location;
transmitting the request from the remote computer over a network to a treatment center;
receiving the request at a server in the treatment center;
transmitting a treatment program from the server to the remote computer, wherein the treatment program corresponds to the treatment request;
delivering the treatment program from the remote computer to a therapeutic device at the remote location; and
executing the treatment program to deliver a therapeutic treatment to the user.

9. The method of claim 8, further comprising selecting a low-level light treatment (“LLLT”) device as the therapeutic device.

10. The method of claim 9, further comprising transmitting the request from the remote computer to the treatment center over the Internet.

11. The method of claim 10, further comprising creating a website hosted at the server as the graphical user interface that is accessed by the remote location over the Internet.

12. The method of claim 11, further comprising requiring a user to purchase a treatment before transmitting the request from the remote computer to the server.

13. The method of claim 12, further comprising processing the purchase at the server.

14. The method of claim 13, further comprising deleting the treatment program from the therapeutic device upon completion of executing the treatment program at the LLLT device.

15. A computer program product embodied on a computer readable medium for remote delivery of a therapeutic treatment, comprising computer code for:
receiving a request for a therapeutic treatment at a remote computer in a remote location;
transmitting the request from the remote computer over a network to a treatment center;
receiving the request at a server in the treatment center;
transmitting a treatment program from the server to the remote computer, wherein the treatment program corresponds to the treatment request;
delivering the treatment program from the remote computer to a therapeutic device at the remote location; and
executing the treatment program to deliver a therapeutic treatment to the user.

16. The computer program product of claim 15, further comprising computer code for selecting a low-level light treatment (“LLLT”) device as the therapeutic device.

17. The computer program product of claim 16, further comprising computer code for transmitting the request from the remote computer to the treatment center over the Internet.

18. The computer program product of claim 17, further comprising computer code for requiring a user to purchase a treatment before transmitting the request from the remote computer to the server.

19. The computer program product of claim 18, further comprising computer code for processing the purchase at the server.

20. The computer program product of claim 19, further comprising computer code for deleting the treatment program from the therapeutic device upon completion of executing the treatment program at the LLLT device.
